(19) United States
(12) Patent Application Publication
(10) Pub. No.: US 2015/0347377 A1
(43) Pub. Date: Dec. 3, 2015

(54) METHOD FOR PROCESSING CONTENTS AND ELECTRONIC DEVICE THEREOF

(71) Applicant: Samsung Electronics Co., Ltd, Gyeonggi-do (KR)

(72) Inventors: Byoung-Jip Kim, Gyeonggi-do (KR); Jin-Mook Lim, Gyeonggi-do (KR); Dong-Hyun Roh, Gyeonggi-do (KR); Kyung-Sub Min, Gyeonggi-do (KR); Seung-Hwan Park, Gyeonggi-do (KR); Jae-Min Park, Seoul (KR)

(21) Appl. No.: 14/719,172

(22) Filed: May 21, 2015

(30) Foreign Application Priority Data
Jun. 2, 2014 (KR) 10-2014-0067140

(51) Int. Cl. G06F 17/27; G06F 17/28; H04L 29/06

(52) U.S. Cl. CPC G06F 17/274; H04L 67/42; G06F 17/289

(57) ABSTRACT

A method to process contents and an electronic device thereof are provided. A method implemented by an electronic device includes transmitting contents to be summarized, attribute information of the contents, and a summarization command to a server. The method also includes receiving contents from the server that are summarized in the server based on the attribute information of the contents and the summarization command.

### CROSS-REFERENCE TO RELATED APPLICATION AND CLAIM OF PRIORITY

The present application is related to and claims the benefit under 35 U.S.C. §119(a) of Korean Patent Application No. 10-2014-0067140, filed on Jun. 2, 2014, which is hereby incorporated by reference for all purposes as if fully set forth herein.

### TECHNICAL FIELD

Various exemplary embodiments of the present disclosure relate to a method for processing contents and an electronic device thereof.

### BACKGROUND

When providing contents such as images or texts, electronic devices automatically summarize and provide the contents in order for users to efficiently consume the contents.

A contents summarization technology is a technology to grasp the important substance from one or several contents, and create summarized contents of a smaller amount than the original contents. The contents summarization technology can be largely divided into extractive summarization and abstractive summarization.

### SUMMARY

This disclosure provides an apparatus and method to summarize and transmit contents.

Various exemplary embodiments of the present disclosure automatically summarize contents consumed by a user in accordance with a user selection and provide the summarized contents in an electronic device such as a smart phone.

In a first embodiment, a method is provided. The method includes transmitting, by an electronic device to a server, contents to be summarized, attribute information of the contents, and a summarization command. The method also includes receiving, by the electronic device from the server contents, that are summarized in the server based on the attribute information of the contents and the summarization command.

In a second embodiment, an electronic device is provided. The electronic device includes a communication interface. The communication interface is configured to transmit and receive contents. The electronic device also includes at least one processor. The at least one processor is configured to transmit contents to be summarized, attribute information of the contents, and a summarization command to a server. The at least one processor is also configured to receive contents from the server that are summarized in the server based on the attribute information of the contents and the summarization command.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or, the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating an example network environment including an example electronic device according to this disclosure;

FIG. 2 is a block diagram illustrating an example electronic device according to this disclosure;

FIGS. 3A and 3B are diagrams illustrating an example interface for summarizing contents in an electronic device according to this disclosure;

FIG. 4 is a diagram illustrating example contents summarized based on designated contents in an electronic device according to this disclosure;

FIG. 5 is a diagram illustrating an example interface provided to summarize contents in an electronic device according to this disclosure;

FIG. 6 is a diagram illustrating an example of providing summarized contents in an electronic device according to this disclosure;

FIG. 7 is a diagram illustrating an example of providing summarized contents in an electronic device according to this disclosure;

FIG. 8 is a diagram illustrating an example method of summarizing contents in an electronic device according to this disclosure;

FIGS. 9A, 9B, and 9C illustrate examples of requesting and providing a summarization of contents in an electronic device according to this disclosure; and

FIGS. 10A and 10B illustrate examples of summarizing received contents in an electronic device according to this disclosure.

### DETAILED DESCRIPTION

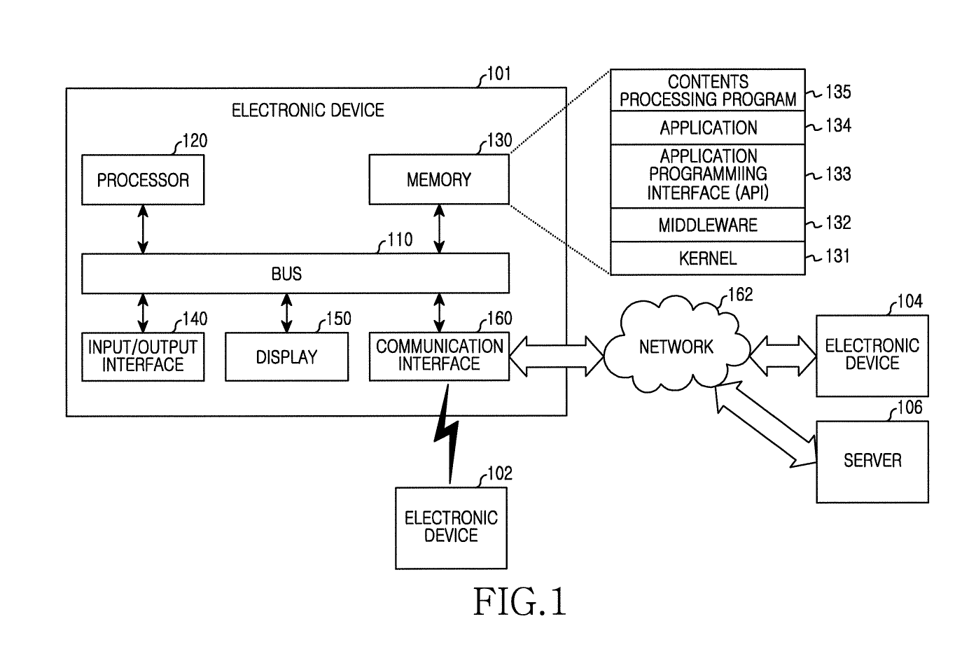

FIGS. 1 through 10B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device and communication system.

An exemplary embodiment of the present disclosure may make various modifications and may have several exemplary embodiments. So, specific exemplary embodiments are illustrated in the drawings and a related detailed description is stated. But, these do not intend to limit the various exemplary embodiments of the present disclosure to a specific embodiment form, and should be understood as including all modifications and/or equivalents or alternatives included in the spirit and technological scope of the various exemplary embodiments of the present disclosure. In relation to a description of the drawing, like constituent elements are denoted by like reference symbols.

The expressions “comprise”, “may comprise” or the like usable in the various exemplary embodiments of the present disclosure indicate the existence of disclosed corresponding functions, operations, constituent elements or the like, and do not limit additional one or more functions, operations, constituent elements or the like. Also, it should be understood that the terms “comprise”. “have” or the like in the various exemplary embodiments of the present disclosure are to designate the existence of features stated in the specification, numerals, steps, operations, constituent elements, components, or a combination of them, and are not to previously exclude the possibility of existence or addition of one or more other features, numerals, steps, operations, constituent elements, components, or combinations of them.

The expressions “or” and the like in the various exemplary embodiments of the present disclosure include any and all combinations of words enumerated together. For example, “A or B” may include A, may include B, or may also include all A and B.

The expressions “1st”, “2nd”, “first”, “second” or the like in the various exemplary embodiments of the present disclosure may modify the various constituent elements of the present disclosure, but do not intend to limit the order, importance and/or the like of the corresponding constituent elements. Also, the expressions may be used to distinguish one constituent element from another constituent element.

When it is mentioned that any constituent element is “connected” or “accessed” to another constituent element, it should be understood that the any constituent element may be directly connected or accessed to the another constituent element or the third constituent element may also exist between the any constituent element and the another constituent element. In contrast, when it is mentioned that any constituent element is “directly connected” or “directly accessed” to another constituent element, it should be understood that the third constituent element does not exist between the any constituent element and the another constituent element.

The terms used in the various exemplary embodiments of the present disclosure are used for just describing specific exemplary embodiments, and do not intend to limit the present disclosure. The expression of singular number may include the expression of plural number unless the context clearly dictates otherwise. Also, all the terms used herein including the technological or scientific terms have the same meaning as those commonly understood by a person having ordinary knowledge in the art which the present disclosure belongs to, and should not be interpreted as having ideal or excessively formal meanings unless defined clearly in an exemplary embodiment of the present disclosure.

An electronic device according to various exemplary embodiments of the present disclosure can be a device including a telecommunication function. For example, the electronic device includes at least one of a smart phone including a telecommunication function, a tablet Personal Computer (PC), a mobile phone, a video phone, an electronic book (e-book) reader, a desktop PC, a laptop PC, a net book computer, a Personal Digital Assistant (PDA), a Portable Media Player (PMP), an MPEG Audio Layer 3 (MP3) player, a mobile medical instrument, a camera, or a wearable device (such as a Head Mounted Display (HMD) such as electronic glasses, electronic clothes, an electronic bracelet, an electronic necklace, an appcessory, an electronic tattoo, or a smart watch), a television, a Digital Video Disc (DVD) player, an audio system, a refrigerator, an air conditioner, a cleaner, an oven, a microwave, a washing machine, an air cleaner, a set-top box, a TV box (such as SAMSUNG HOMESYNC™, APPLETV®, or GOOGLE TV®), a game console, an electronic dictionary, an electronic locking system, a camcorder, a medical instrument (such as Magnetic Resonance Angiography (MRA), Magnetic Resonance Imaging (MRI), Computerized Tomography (CT), a moving-camera, an ultrasonic machine, and the like), a navigation device, a Global Positioning System (GPS) receiver, an Event Data Recorder (EDR), a Flight Data Recorder (FDR), a car infotainment device, an electronic equipment for ship (such as a navigation device for ship, a gyrocompass, and the like), avionics, a security instrument, an industrial or home robot, a part of furniture or building/structure, an electronic board, an electronic signature receiving device, a projector, or various metering instruments (such as tap water, electricity, gas, radio wave metering instrument, or the like). The electronic device according to this disclosure can be one or a combination of more of the aforementioned various devices. Also, it is obvious to those skilled in the art that the electronic device according to the various exemplary embodiments of the present disclosure is not limited to the aforementioned instruments.

An electronic device according to this disclosure will be described with reference to the accompanying drawings. The term ‘user’ used in the various exemplary embodiments of the present disclosure denotes a person who uses the electronic device or a device (such as an artificial intelligent electronic device) which uses the electronic device.

FIG. 1 is a diagram illustrating an example network environment including an example electronic device according to this disclosure. Referring to FIG. 1, the electronic device 101 includes at least one of a bus 110, a processor 120, a memory 130, an input/output interface 140, a display 150, or a communication interface 160. The bus 110 is a circuit connecting the aforementioned constituent elements with one another, and forwarding a communication signal (such as control message) between the aforementioned constituent elements.

The processor 120 receives instructions from the aforementioned other constituent elements (such as the memory 130, the input/output interface 140, the display 150, or the communication interface 160) through the bus 110, deciphers the received instructions, and executes one or more operations or data processes according to the deciphered instructions.

At least one or more processors 120 is included in the electronic device 101 and performs a designated function of the electronic device 101. The processor 120 includes one or more Application Processors (AP) and one or more Micro Controller Units (MCU). The processor 210 includes one or more MCUs as applications, or is operatively connected with one or more MCUs. In FIG. 1, the AP and the MCU are included within one Integrated Circuit (IC) package, and can be constructed separately and included within different IC packages, respectively. The MCU is included in the IC package of the AP and constructed with one IC package. As illustrated, the processor 120 includes the AP or the MCU as constituent elements thereof, but this is an exemplary embodiment for clear understanding, and it is obvious that the processor 120 performs an operation of the AP and/or MCU.

The AP drives an operating system or an application program (or application), controls a plurality of hardware or software constituent elements connected to the AP, and performs processing and operations of various data including multimedia data. The AP is, for example, implemented as a System On Chip (SoC). The processor 120 further includes a Graphic Processing Unit (GPU).

The MCU is a processor that is configured to perform a designated operation. The MCU acquires sensing information through one or more designated motion sensors (such as a gyro sensor, an acceleration sensor or a geomagnetic sensor), compares the acquired sensing information, and determines an operation state of a designated sensor with reference to a database of the electronic device 101. The AP or MCU loads to a volatile memory an instruction or data received from a non-volatile memory connected to each of the AP and MCU or at least one of other constituent elements, and processes the loaded instruction or data. Also, the AP or MCU stores in the non-volatile memory data received from at least one of other constituent elements or created by at least one of the other constituent elements.

The memory 130 stores an instruction or data received from the processor 120 or the other constituent elements (such as the input/output interface 140, the display 150, or the communication interface 160) or created by the processor 120 or the other constituent elements. The memory 130 includes programming modules such as a kernel 131, a middleware 132, an Application Programming Interface (API) 133, an application 134 or the like. The aforementioned programming modules each are comprised of software, firmware, hardware or a combination of at least two or more thereof.

The kernel 131 controls or manages system resources (such as the bus 110, the processor 120, the memory 130 or the like) used for executing operations or functions implemented by the remnant other programming modules, for example, the middleware 132, the API 133, or the application 134. Also, the kernel 131 provides an interface enabling the middleware 132, the API 133, or the application 134 to connect and control or manage the individual constituent element of the electronic device 101. The middleware 132 performs a relay role of enabling the API 133 or the application 134 to communicate and exchanges data with the kernel 131. Also, in relation to work requests received from the application 134, the middleware 132 performs controls (such as scheduling or load balancing) over the work requests using a method of allocating at least one application among the applications 134 priority order capable of using the system resources (such as the bus 110, the processor 120, the memory 130, or the like) of the electronic device 101.

The API 133 is an interface enabling the application 134 to control a function provided by the kernel 131 or the middleware 132. The API 133 includes at least one interface or function (such as instruction) for file control, window control, picture processing, character control, or the like. The application (or processor) 134 is an application related with information exchange between the electronic device 101 and an external electronic device (such as an electronic device 102 or an electronic device 104). The application related with the information exchange includes a notification relay application for relaying specific information to the external electronic device, or a device management application for managing the external electronic device. The application 134 includes an application additionally designated in accordance to an attribute (such as the kind of an electronic device) of the external electronic device (such as the electronic device 102 or the electronic device 104).

The contents processing program 135 determines whether it can summarize various contents provided in the electronic device 101, and notifies the summarization or non-summarization of the contents to a user through a display 150 of the electronic device 101 or at least one output device (such as a speaker) thereof. The contents processing program 135 acquires designated contents based on a user input, and transmits the acquired contents to a connected contents summarization device (such as the server 106) based on the communication interface 160. In transmitting the contents to the server 106, the contents processing program 135 transmits a summarization command having attribute information of the contents or information about a contents summarization method stored in setting information of the contents processing program 135. If the electronic device 101 performs the contents summarization device, the contents processing program 135 receives contents (such as the original contents) from at least one other electronic device (such as the electronic device 102) connected through the communication interface 160 and summarizes the received contents based on the summarization command. The contents processing program 135 creates the summarized contents as data of a designated type (such as a data format such as an image, an audio, a video, and a text), and transmits the created data to the electronic device 102 having transmitted the original contents. In transmitting the summarized contents to the electronic device 102, the contents processing program 135 transmits attribute information of the contents summarized based on the summarization command together. The contents processing program 135 loads a designated program in accordance to a data type of the summarized contents received from the server 106 and provides the summarized contents through the loaded program.

The contents processing program 135 transmits contents to be summarized, attribute information of the contents, and a summarization command, to the server 106, and receives contents summarized in the server 106 based on the attribute information of the contents and the summarization command. Based on the attribute information of the contents summarized in the server 106, the contents processing program 135 displays the received contents as one or more of a text, a video, an audio, and an image. The contents processing program 135 changes at least a portion of the summarized contents displayed on the display 150 in accordance to a designated input detected in the electronic device 101. Based on the attribute information of the received contents, the contents processing program 135 controls a method of displaying the received contents. The contents processing program 135 displays contents corresponding to at least one level among two or more levels of a summarized text distinguished based on setting information of the received contents. The contents processing program 135 determines attribute information of the received contents including information corresponding to at least one of a data type of the received contents, a program loaded corresponding to the data type, and a corresponding level when the received contents are distinguished into two or more levels in accordance to priority order. The contents processing program 135 determines at least one of an Internet page, a document including at least one image or text, an image, an audio, and a video, as contents to be summarized. The contents processing program 135 can select, omit, delete, revise, combine or rearrange at least a portion of contents to be summarized based on a summarization command, thereby creating or receiving summarized contents from the server 106. The contents processing program 135 determines a priority order for at least a portion of the contents to be summarized. The contents processing program 135 distinguishes the contents to be summarized into two or more levels in accordance to the determined priority order based on the summarization command. The contents processing program 135 is included in the application 134, or is stored as a separate program in the memory 130.

The input/output interface 140 forwards an instruction or data, which is inputted from a user through a sensor (such as an acceleration sensor, a gyro sensor) or an input device (such as a keyboard or a touch screen), for example, to the processor 120, the memory 130, or the communication interface 160 through the bus 110. For example, the input/output interface 140 provides data about a user's touch inputted through the touch screen, to the processor 120. Also, the input/output interface 140 outputs through an output device (such as a speaker or a display) an instruction or data that is received from the processor 120, the memory 130, or the communication interface 160 through the bus 110. For example, the input/output interface 140 outputs voice data that is processed through the processor 120 to the user through the speaker. The display 150 displays a variety of information (such as multimedia data, text data, or the like) to a user. Also, the display 150 includes a touch screen in which with an input means touches or hovers a display and inputs an instruction.

The communication interface 160 establishes communication between the electronic device 101 and the external device (such as the electronic device 104 or server 106). For example, the communication interface 160 is connected to a network 162 through wireless communication or wired communication and communicates with the external device. The wireless communication includes at least one of Wireless Fidelity (WiFi), BLUETOOTH® (BT), Near Field Communication (NFC), Global Positioning System (GPS) or cellular communication (such as Long Term Evolution (LTE), LTE-Advanced (LTE-A), Code Division Multiple Access (CDMA), Wireless CDMA (WCDMA), Universal Mobile Telecommunication System (UMTS), Wireless Broadband (WiBro), Global System for Mobile Communications (GSM), or the like). The wired communication may, for example, include at least one of a Universe Serial Bus (USB), a High Definition Multimedia Interface (HDMI), a Recommended Standard-232 (RS-232), or a Plain Old Telephone System (POTS).

The network 162 is a telecommunication network. The telecommunication network includes at least one of a computer network, the Internet, the Internet of things or a telephone network. In an embodiment, a protocol (such as a transport layer protocol, a data link layer protocol, or a physical layer protocol) for communication between the electronic device 101 and the external device is supported in at least one of the application 134, the application programming interface 133, the middleware 132, the kernel 131, or the communication interface 160.

The server 106 performs at least one operation among operations (or functions) implemented in the electronic device 101, thereby being able to support driving of the electronic device 101. For example, the server 106 includes a processor 120 controlling to perform various exemplary embodiments of the present disclosure described herein in the electronic device 101 or a server module (or a server processor) capable of supporting a specific module designated to perform various exemplary embodiments. For example, the server module includes the processor 120 or at least one constituent element of a specific module and perform (such as instead perform) at least one operation among operations performed by the processor 210 or the specific module.

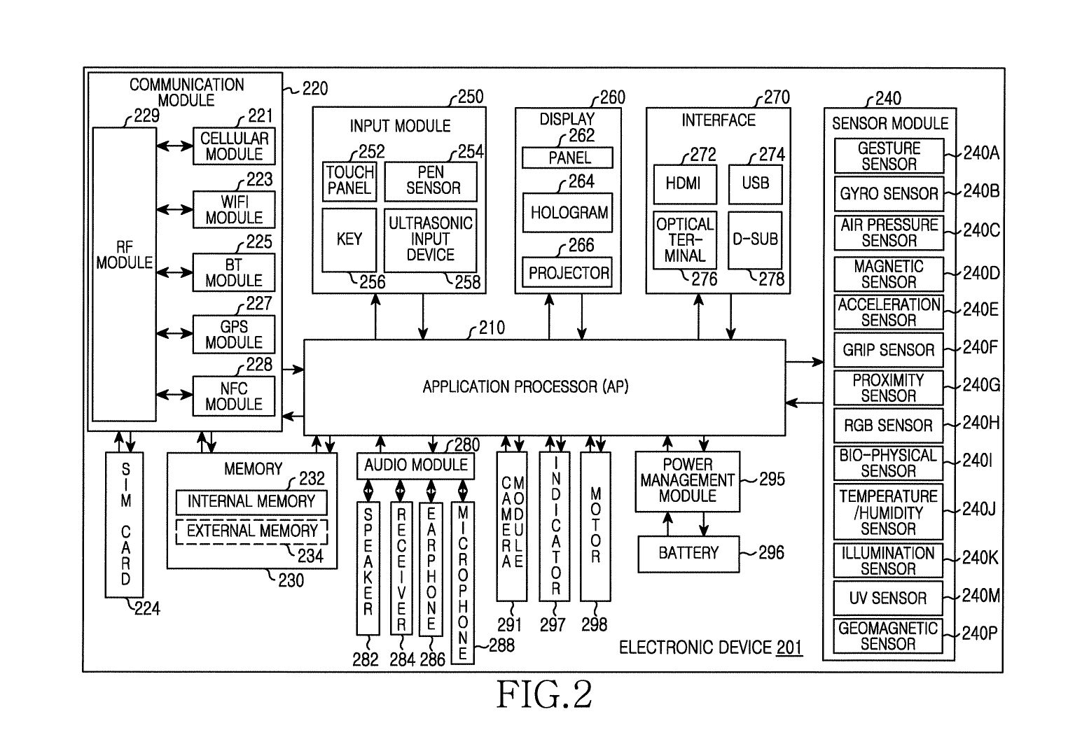

FIG. 2 is a block diagram illustrating a construction of an example electronic device according to this disclosure. The electronic device 201 includes the whole or part of the electronic device 101 illustrated in FIG. 1. Referring to FIG. 2, the electronic device 201 includes one or more Application Processors (APs) 210, a communication module 220, a Subscriber Identification Module (SIM) card 224, a memory 230, a sensor module 240, an input device 250, a display 260, an interface 270, an audio module 280, a camera module 291, a power management module 295, a battery 296, an indicator 297, and a motor 298. The AP 210 drives an operating system or an application program, controls a plurality of hardware or software constituent elements connected to the AP 210, and performs processing and operations of various data including multimedia data. The AP 210 is, for example, implemented as a System on Chip (SoC). The AP 210 further includes a Graphic Processing Unit (GPU).

The communication module 220 (such as the communication interface 160) performs data transmission/reception in communication between other electronic devices (such as the electronic device 104 or the server 106) connected with the electronic device 201 (such as the electronic device 101) through a network. The communication module 220 includes a cellular module 221, a WiFi module 223, a BT module 225, a GPS module 227, an NFC module 228, and a Radio Frequency (RF) module 229.

The cellular module 221 provides voice telephony, video telephony, a text service, an Internet service, or the like through a communication network (such as LTE, LTE-A, CDMA, WCDMA, UMTS, WiBro, GSM, or the like). Also, the cellular module 221 performs electronic device distinction and authorization within a communication network using a subscriber identification module (such as the SIM card 224). In an embodiment, the cellular module 221 performs at least some functions among functions that the AP 210 provides. For example, the cellular module 221 performs at least a part of a multimedia control function.

The cellular module 221 includes a Communication Processor (CP). Also, the cellular module 221 is, for example, implemented as a SoC. In FIG. 2, the constituent elements such as the cellular module 221 (such as the communication processor), the memory 230, the power management module 295, or the like are illustrated as constituent elements separate from the AP 210. However, the AP 210 can be implemented to include at least some (such as the cellular module 221) of the aforementioned constituent elements. The AP 210 or the cellular module 221 (such as the communication processor) loads to a volatile memory an instruction or data received from a nonvolatile memory connected to each of the AP 210 and the cellular module 221 or at least one of other constituent elements, and processes the loaded instruction or data. Also, the AP 210 or the cellular module 221 stores data received from at least one of other constituent elements or created in at least one of the other constituent elements in the nonvolatile memory.

The WiFi module 223, the BT module 225, the GPS module 227, or the NFC module 228 each include a processor for processing data transmitted/received through the corresponding module. In FIG. 2, each of the cellular module 221, the WiFi module 223, the BT module 225, the GPS module 227, or the NFC module 228 are illustrated as a separate block. But, at least some (such as two or more) of the cellular module 221, the WiFi module 223, the BT module 225, the GPS module 227, or the NFC module 228 can be included within one Integrated Circuit (IC) or IC package. For example, at least some (such as a communication processor corresponding to the cellular module 221 and a WiFi processor corresponding to the WiFi module 223) of the processors corresponding to the cellular module 221, the WiFi module 223, the BT module 225, the GPS module 227 or the NFC module 228 can be implemented as one SoC.

The RF module 229 performs data transmission/reception, such as RF signal transmission/reception. The RF module 229 includes a transceiver, a Power Amplifier Module (PAM), a frequency filter, a Low Noise Amplifier (LNA), or the like. Also, the RF module 229 further includes components, such as a conductor, a conductive line or the like for transmitting/receiving an electromagnetic wave on a free space in wireless communication. As illustrated in FIG. 2, the cellular module 221, the WiFi module 223, the BT module 225, the GPS module 227, and the NFC module 228 share one RF module 229 with each other. But, at least one of the cellular module 221, the WiFi module 223, the BT module 225, the GPS module 227, or the NFC module 228 can perform RF signal transmission/reception through a separate RF module.

The SIM card 224 is a card including a subscriber identification module, and is inserted into a slot provided in a specific position of the electronic device 201. The SIM card 224 includes unique identification information (such as an Integrated Circuit Card ID (ICCID)) or subscriber information (such as an International Mobile Subscriber Identity (IMSI)). The memory 230 (such as the memory 130) includes an internal memory 232 or an external memory 234. The internal memory 232 includes at least one of a volatile memory (such as a Dynamic Random Access Memory (DRAM), a Static RAM (SRAM), a Synchronous Dynamic RAM (SDRAM), and the like) or a nonvolatile memory (such as a One-Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, and the like). The internal memory 232 is a Solid State Drive (SSD). The external memory 234 further includes a flash drive, for example, Compact Flash (CF), Secure Digital (SD), micro-SD, Mini-SD, extreme Digital (xD), a memory stick, or the like. The external memory 234 is operatively connected with the electronic device 201 through various interfaces. In an embodiment, the electronic device 201 further includes a storage device (or storage media) such as a hard drive.

The sensor module 240 measures a physical quantity or senses an active state of the electronic device 201 and converts measured or sensed information into an electric signal. The sensor module 240 includes at least one of a gesture sensor 240A, a gyro sensor 240B, an air pressure sensor 240C, a magnetic sensor 240D, an acceleration sensor 240E, a grip sensor 240F, a proximity sensor 240G, a color sensor 240H (such as a Red, Green, Blue (RGB) sensor), a bio-physical sensor 240I, a temperature/humidity sensor 240J, an illumination sensor 240K, a Ultraviolet (UV) sensor 240M, or a Geomagnetic sensor 240P. Additionally or alternatively, the sensor module 240 includes an E-nose sensor, an Electromyography (EMG) sensor, an Electroencephalogram (EEG) sensor, an Electrocardiogram (ECG) sensor, an Infrared (IR) sensor, an iris sensor, a fingerprint sensor, or the like. The sensor module 240 further includes a control circuit for controlling at least one or more sensors belonging therein.

The input device 250 includes a touch panel 252, a (digital) pen sensor 254, a key 256, or an ultrasonic input device 258. The touch panel 252 recognizes a touch input in at least one method among a capacitive overlay method, a pressure sensitive method, an infrared beam method, or an acoustic wave method. Also, the touch panel 252 further includes a control circuit. In the capacitive overlay method, physical contact or proximity recognition is possible. The touch panel 252 further includes a tactile layer. In this case, the touch panel 252 provides a tactile response to a user.

The (digital) pen sensor 254 can be, implemented using a method being the same or similar to a method of receiving a user's touch input or a separate sheet for detection. The key 256 includes a physical button, an optical key, or a keypad. The ultrasonic input device 258 is a device capable of checking data by sensing a sound wave with a microphone (such as the microphone 288) of the electronic device 201 through an input tool generating an ultrasonic signal. The ultrasonic input device 258 can perform wireless detection. By using the communication module 220, the electronic device 201 also receives a user input from an exterior device (such as a computer or a server) connected with the communication module 220.

The display 260 (such as the display 150) includes a panel 262, a hologram device 264, or a projector 266. The panel 262 is a Liquid Crystal Display (LCD), an Active-Matrix Organic Light-Emitting Diode (AMOLED), or the like. The panel 262 is implemented to be flexible, transparent, or wearable. The panel 262 can also be constructed together with the touch panel 252 as one module. The hologram device 264 shows a three-dimensional image in the air using interference of light. The projector 266 displays a video by projecting light to a screen. The screen is located inside or outside the electronic device 201. The display 260 further includes a control circuit for controlling the panel 262, the hologram device 264, and the projector 266.

The interface 270 includes an HDMI 272, a USB 274, an optical interface 276, or a D-subminiature (D-sub) 278. The interface 270 is included in the communication interface 160, for example as illustrated in FIG. 1. Additionally or alternatively, the interface 270 includes a Mobile High-definition Link (MHL) interface, a Secure Digital/Multi Media Card (SD/MMC) interface, or an Infrared Data Association (IrDA) standard interface.

The audio module 280 converts sound and an electric signal interactively. At least some constituent elements of the audio module 280 are included in the input/output interface 140, for example as illustrated in FIG. 1. The audio module 280 processes sound information inputted or outputted through a speaker 282, a receiver 284, an earphone 286, the microphone 288, or the like. The camera module 291 is a device capable of taking a still picture and a moving picture. The camera module 291 includes one or more image sensors (such as a front sensor or rear sensor), a lens, an Image Signal Processor (ISP), or a flash (such as an LED or a xenon lamp).

The power management module 295 manages electric power of the electronic device 201. Also, the power management module 295 includes a Power Management Integrated Circuit (PMIC), a charger Integrated Circuit (IC), or a battery or fuel gauge. The PMIC is mounted within an integrated circuit or a SoC semiconductor. A charging method is divided into wired and wireless charging methods. The charger IC charges a battery, and prevents the introduction of overvoltage or overcurrent from an electric charger. The charger IC includes a charger IC of at least one of the wired charging method or the wireless charging method. As the wireless charging method, there are, for example, a magnetic resonance method, a magnetic induction method, an electromagnetic wave method, or the like. Supplementary circuits for wireless charging, for example, circuits such as a coil loop, a resonance circuit, a rectifier, or the like can be added.

The battery fuel gauge measures a level of the battery 296, a voltage in charging, an electric current, or a temperature. The battery 296 stores or generates electricity, and supplies power to the electronic device 201 using the stored or generated electricity. The battery 296 includes a rechargeable battery or a solar battery. The indicator 297 displays a specific state of the electronic device 201 or part (such as the AP 210) thereof, such as a booting state, a message state, a charging state, or the like. The motor 298 converts an electric signal into a mechanical vibration. The electronic device 201 can include a processing device (such as a GPU) for mobile TV support. The processing device for mobile TV support processes media data according to the standards of Digital Multimedia Broadcasting (DMB), Digital Video Broadcasting (DVB), a media flow, or the like.

The aforementioned constituent elements of an electronic device according to this disclosure are each comprised of one or more components, and a name of the corresponding constituent element can be different according to the kind of the electronic device. The electronic device according to this disclosure includes at least one of the aforementioned constituent elements, and can omit some constituent elements or can further include additional other constituent elements. Also, some of the constituent elements of the electronic device according to this disclosure are combined and constructed as one entity, thereby being able to identically perform the functions of the corresponding constituent elements before combination.

The electronic device according to this disclosure can be electronic devices of various types such as smart phones, tablet PCs, or the like, and can include constituent elements such as elements illustrated in FIG. 1 and FIG. 2. Further, the electronic device reflects own pattern of a user who variously uses several functions of the electronic device, thereby predicting a battery use allowable time, and suitably controls a display time point of a warning message such as discharge, charge, power saving, and the like.

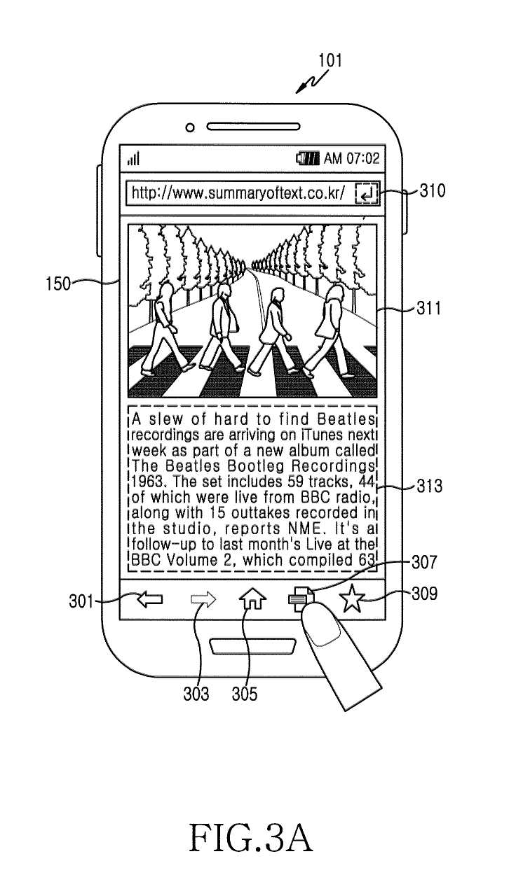

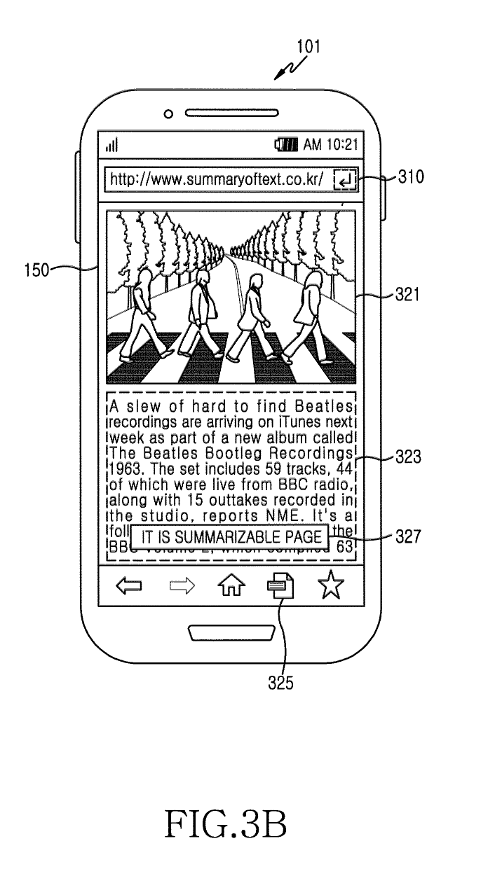

The following description is made for various exemplary embodiments of an operation of controlling to summarize a text in the electronic device 101. FIGS. 3A and 3B are diagrams illustrated an example interface for summarizing contents in an electronic device according to this disclosure. Various exemplary embodiments of the present disclosure are described herein with reference to FIG. 3A.

The electronic device 101 provides (such as displays) contents including a text through the display 150. The electronic device 101 extracts various data such as text data, image data, audio data, or data (such as document data) of a designated type (or format) from the contents including the text. The electronic device 101 determines a possibility of summarization of the contents. The electronic device 101 controls to perform summarizing the text included in the contents through a designated method (such as a method of selecting a summarization execution or summarization request object displayed on the display 150).

The electronic device 101 can be in a state of displaying a designated page of the Internet on the display 150 through the communication interface 160. In displaying the page of the Internet, the electronic device 101 use an Internet surfing program provided by the electronic device 101. The internet surfing program displayed on the display 150 displays an Internet address display region (such as a Uniform Resource Locator (URL) display region 310), an Internet page display region (such as a region including an image 311 or text data 313), and at least one object (such as an icon) for controlling the Internet surfing program. For example, the at least one object for controlling the Internet surfing program is an icon performing a designated operation based on the Internet surfing program, such as an icon 301 controlling to move to a previous page of the Internet page displayed on the display 150, an icon 303 controlling to move to a next page of the Internet page, an icon 305 controlling to move to a designated Internet page, an icon 309 controlling to display a menu of a favorite function, and an icon 307 (such as a contents summarization icon) controlling to summarize and provide a text included in the Internet page.

The electronic device 101 displays an address of the Internet page displayed on the display 150, in the URL display region 310 through the Internet surfing program displayed on the display 150. The electronic device 101 displays at least a portion of contents corresponding to the address of the Internet page, in the Internet page display region of the Internet surfing program. For example, in accordance to the URL address, the electronic device 101 displays the included at least one image 311 in a designated position of the Internet page display region of the display 150, and displays at least a portion 313 of a text included in the Internet page in a designated position of the Internet page display region. If selecting the contents summarization icon 307 displayed through the Internet surfing program of the display 150, the electronic device 101 controls to summarize the contents provided to the Internet page displayed through the Internet surfing program.

If requesting to perform a text summarization operation (such as selecting the contents summarization icon 307), the electronic device 101 determines contents being an object for performing the text summarization operation. In deciding the contents for performing the text summarization operation, the electronic device 101 determines contents, image data included in the contents, audio data, text data, or data (such as document data) of a designated type based on an attribute (such as a data type or data format) of the contents so as to transmit the determined contents, image data, audio data, text data, or data (such as document data) to the server 106 performing the text summarization operation. If the attribute of the contents is an Internet page operating based on the Internet surfing program, the electronic device 101 requests to summarize a text included in the contents (such as select the text summarization icon) 307). If deciding the attribute of the contents as the Internet page, the electronic device 101 acquires an address of the Internet page, and transmits information requesting to summarize the address (such as URL address) of the Internet page and the contents included in the Internet page to the server 106.

If the attribute of the contents is a received e-mail, the electronic device 101 stores as document data at least a portion of a text included in the received e-mail. In storing as the document data the text included in the received e-mail, the electronic device 101 downloads the e-mail, or creates new data based on at least the portion of the text included in the e-mail. The electronic device 101 transmits information requesting to summarize the stored document data and the contents included in the document data, to the server 106. If the attribute of the contents is document data including an image and/or text stored in the memory 130 of the electronic device 101, the electronic device 101 transmits information requesting to summarize the document data and the text included in the document data, to the sever 106. If the attribute of the contents is an image including a text, the electronic device 101 transmits information requesting to extract (or request to extract) the text included in the image data and summarize the extracted text, to the server 106. If the attribute of the contents is audio or video data including a voice, the electronic device 101 transmits information requesting to extract (or request to extract) the voice included in the audio or video as a text and summarize the extracted text to the server 106.

Various exemplary embodiments of the present disclosure are described herein with reference to FIG. 3B. If contents displayed on the display 150 are summarizable contents, the electronic device 101 outputs a notification that the contents are summarizable. If the contents are summarizable, the electronic device 101 outputs a designated notification through the display 150 of the electronic device 101 or at least one output device (such as the speaker 282, the motor 298, and the indicator 297) operatively connected with the electronic device 101. The electronic device 101 displays an Internet page based on an Internet surfing program on the display 150. At a time point of displaying a text included in the Internet page on the display 150 (such as a region including an image 321 or text data 323) or at a time point of loading the Internet page, the electronic device 101 performs deciding a language of the text included in the Internet page.

If deciding the language of the text included in the Internet page, the electronic device 101 displays a notification 327 (such as ‘It is summarizable page’) that the Internet page is summarizable in a designated position of the display 150. If displaying the notification 327 on the display 150, after displaying the notification 327 during a designated time (such as a time being set to setting information among one to three seconds), the electronic device 101 releases the displaying of the notification 327. When detecting that the language of the text included in the Internet page is two or more, if deciding at least one text language among two or more text languages, the electronic device 101 determines that a corresponding text included in the Internet page is summarizable. In displaying a notification of whether a text displayed through the display 150 is a summarizable text, it can be applied to a text included in data of various types (such as formats) such as an electronic message (such as an e-mail, news) and document data transmitted or received (or transceived) through the communication interface 160 in the electronic device 101 without being limited to the text included in the Internet page.

In displaying a contents summarizable state, the electronic device 101 displays an active/inactive state of the contents summarization icon 325 displayed on the display 150. If deciding that the text of the Internet page displayed on the display 150 through the Internet surfing program is the summarizable text, the electronic device 101 displays the active state of the contents summarization icon 307 of the Internet surfing program. If being able to determine the language of the text included in the Internet page, the electronic device 101 determines that it summarize the text included in the Internet page. If not being able to determine the language of the text included in the Internet page, the electronic device 101 determines that it cannot summarize the text included in the Internet page. If the electronic device 101 determines that it cannot summarize the text included in the Internet page, the electronic device 101 displays the inactive state of the contents summarization icon 307 of the Internet surfing program, or releases the displaying of the contents summarization icon 307. The electronic device 101 determines an object (such as an advertisement image) determined irrelevant to the substance of the Internet page based on contents of the Internet page. If deciding at least one object irrelevant to the substance of the Internet page, the electronic device 101 displays the inactive state of the contents summarization icon 307 controlling to summarize the Internet page. If selecting the contents summarization icon 307 displayed through the Internet surfing program of the display 150, the electronic device 101 controls to summarize the Internet page displayed through the Internet surfing program.

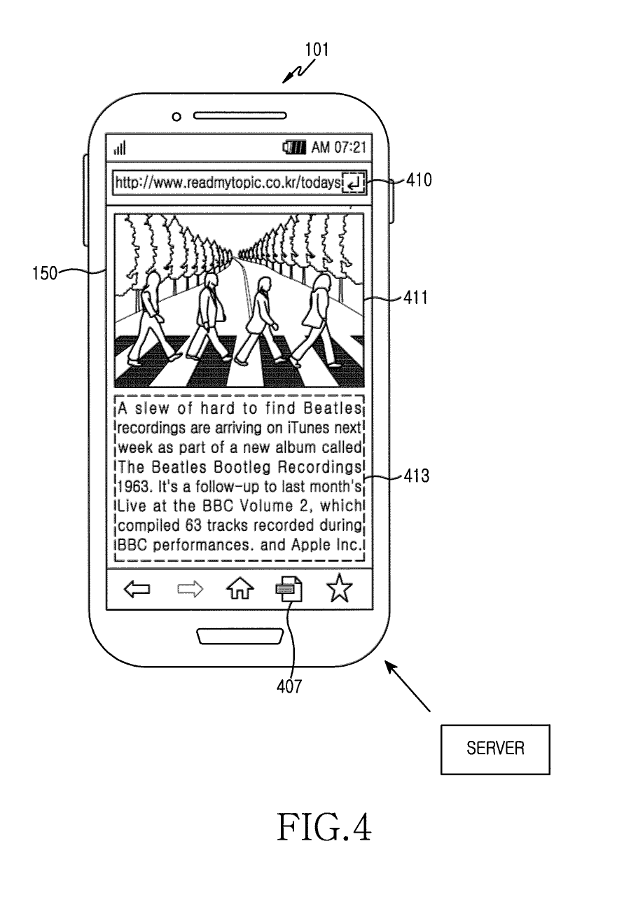

FIG. 4 is a diagram illustrating example contents summarized based on designated contents in an example electronic device according to this disclosure. The electronic device 101 displays summarized contents received from the server 106 on the display 150. The summarized contents that the electronic device 101 displays on the display 150 are displayed through a program of processing contents becoming the original of the summarized contents, and can also be displayed through a specific program (such as the contents processing program 135) of processing the summarized contents. In displaying the summarized contents received from the server 106 on the display 150, the electronic device 101 displays the summarized contents in a method (such as an image or text arrangement method) of displaying the original contents on the display 150. If requesting to summarize the original contents (such as the contents of the Internet page displayed on the display 150 of FIG. 3A), the electronic device 101 displays an image 411 and/or summarized text 413 on the display 150 of the electronic device 101 in accordance to the displaying method of the original contents (such as the displaying method of the image 311 or text 313 of FIG. 3A). In deciding a method of displaying the summarized contents on the display 150 based on the displaying method of the original contents, the electronic device 101 determines the displaying method of the summarized contents with reference to a header of data of the summarized contents received from the server 106, or data about setting information received together with the data of the summarized contents.

In transmitting data of a summarized text to the electronic device 101, the server 106 transmits the summarized text as an address of an Internet page including the summarized text, or transmits the summarized text as document data including the summarized contents. Based on an attribute (or format) of the original contents, the electronic device 101 transmits the summarized contents as the address of the Internet page, or transmit the summarized contents as the document data or image. Based on the received data, the electronic device 101 displays the summarized text 413 on the display 150. If the original contents are data of the Internet page, the electronic device 101 receives an address (such as a URL address 410) of the Internet page designated in the server 106 from the server 106, and loads the received address of the Internet page to the Internet surfing program and displays summarized contents. Also, the server 106 scans the summarized contents as an image based on the original contents and transmits the image scanning the summarized contents to the electronic device 101. In an embodiment, the electronic device 101 displays a specific image (such as the image 311 of FIG. 3A), such as the image 411, in a designated position of the display 150 displaying the summarized text 413 with reference to the original contents. Similarly, FIG. 4 illustrates that the summarized text is displayed including at least one (such as the image 411) of images included in the original contents, but the electronic device 101 can display the summarized text excluding the image.

The electronic device 101 provides a service capable of again summarizing the summarized contents. The electronic device 101 displays a contents summarization icon 407 in a designated position of the display 150 displaying the summarized contents. If selecting the contents summarization icon 407, the electronic device 101 transmits information requesting to summarize data of the summarized contents displayed on the display 150 and a text included in the summarized content (such as data of a summarized text) to the server 106.

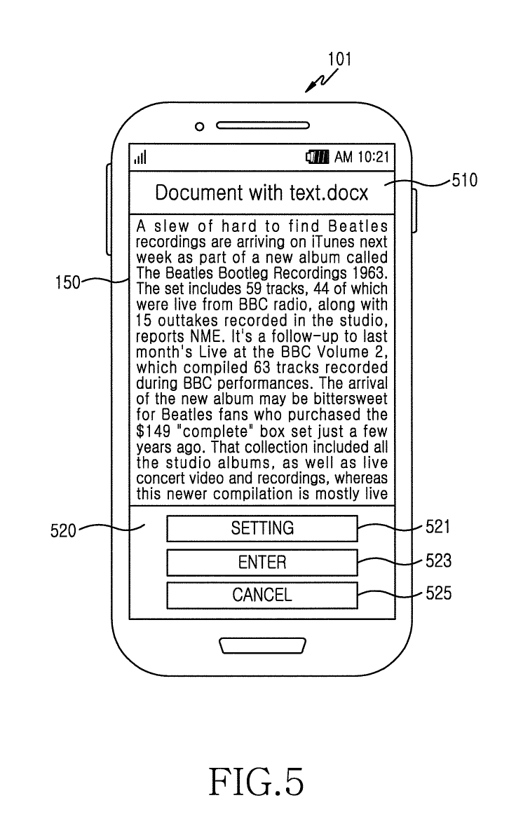

FIG. 5 is a diagram illustrating an example interface provided to summarize contents in an electronic device according to this disclosure. Without limiting the summarizable contents to the Internet page as described herein, the electronic device 101 is provided to summarize data of various types supported in the electronic device 101. The electronic device 101 summarizes and provides data of various types in accordance to user's selection. The electronic device 101 requests the server 106 to summarize document data including an image and/or text. For example, the electronic device 101 displays the document data on the display 150 through a program of processing the document data (such as ‘Document with text.docs’ 510), and displays a menu 520 of providing a function of the program of processing the document data such as a setting menu 521 and a cancel menu 525, in a portion (such as a designated position) of the document data. The electronic device 101 displays a contents summarization icon requesting to summarize the document data displayed on the display 150, like an extract menu 523, as a portion of the menu 520 in accordance to a form of the menu 520.

As described above, the electronic device 101 provides a contents summarization function (such as the contents summarization icon 307 or the extract menu 523) of requesting to summarize the original contents in a designated position of a program of processing the original contents for summarizing.

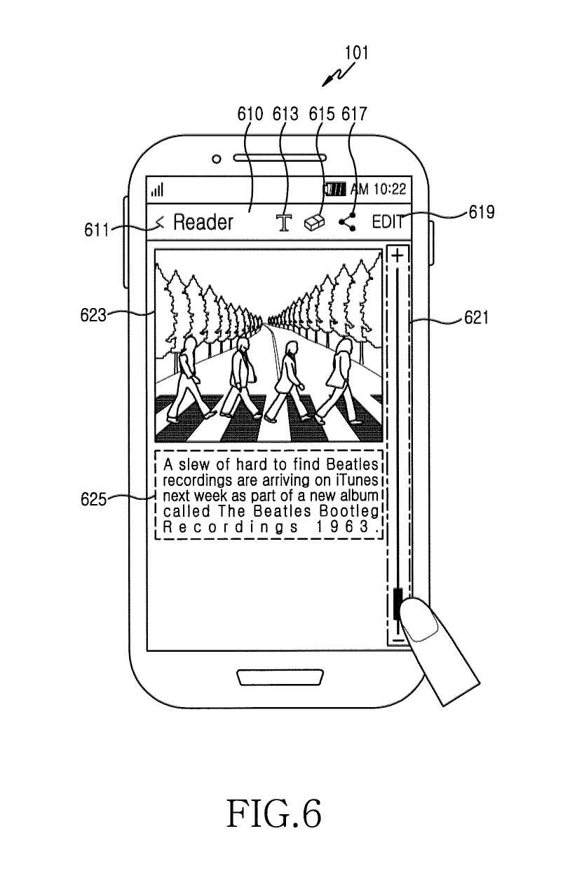

FIG. 6 is a diagram illustrating an example of providing summarized contents in an electronic device according to this disclosure. The electronic device 101 transmits the original contents for summarizing, to the server 106, receives summarized contents from the server 106, and displays the received summarized contents on the display 150 of the electronic device 101. In displaying the summarized contents received from the sever 106 on the display 150 of the electronic device 101, the electronic device 101 displays the summarized contents through a program (such as the contents processing program 135) designated to display the summarized contents, or displays the summarized contents through the designated program capable of processing a data type (or format) of the received summarized contents. The electronic device 101 displays the summarized contents through the contents processing program 135. The contents processing program 135 provides at least one function for displaying the summarized contents received from the server 106.

The electronic device 101 provides various functions for displaying the summarized contents such as a function 611 of moving to a previous page of a current page, a text input function 613, an eraser function 615, a function 617 of loading related contents, and a setting entry function 619, as various examples of a function of the contents processing program 135, in a function display region 610 of the display 150. In displaying the summarized contents received from the server 106 on the display 150, the electronic device 101 displays an image 623 and/or text 625 based on attribute information of the received summarized contents. Further, at a time point of transmitting information requesting to summarize the original contents, the electronic device 101 requests the server 106 to distinguish the original contents into two or more levels (such as levels indicating the extent of summarization) based on setting information of the contents processing program 135 and summarize the original contents.

The electronic device 101 checks that the summarized contents are summarized into two or more levels based on attribute information of the summarized contents received from the server 106. If the electronic device 101 checks that the summarized contents are summarized into two or more levels, in other words, if the level of the summarized contents is divided into two or more levels based on setting information of the electronic device 101 (such as the setting information of the contents processing program 135), the electronic device 101 displays at least one of the two or more divided levels of the summarized contents in accordance to information designated to be basically displayed on the display 150. According to one exemplary embodiment, the electronic device 101 receives summarized contents of an Internet page (such as the contents of the address of the Internet page illustrated in FIG. 3A and the original contents) from the server 106. The electronic device 101 checks that the summarized contents are acquired by distinguishing the original contents into three levels in accordance to the strength of summarization and summarizing the distinguished original contents, based on attribute information of the summarized contents received together with the summarized contents. If the summarized contents are distinguished into two or more levels based on the setting information of the contents processing program 135, the electronic device 101 displays the substance of summarized contents of a firstly displayed level (such as a first level) on the display 150.

Referring to FIG. 6, if receiving summarized contents distinguishing text data of the original contents into three levels, the electronic device 101 displays the first level (such as a level of the strongest extent of summarization) set to be firstly displayed, on the display 150, and displays a function (such as a side bar 621) capable of adjusting the level of the summarized contents, in a designated position of the display 150. Or, the electronic device 101 sets to change the level of the summarized contents displayed on the display 150, through an input operation (such as zoom-in/zoom-out inputted to the display 150) designated through setting of the contents processing program 135.

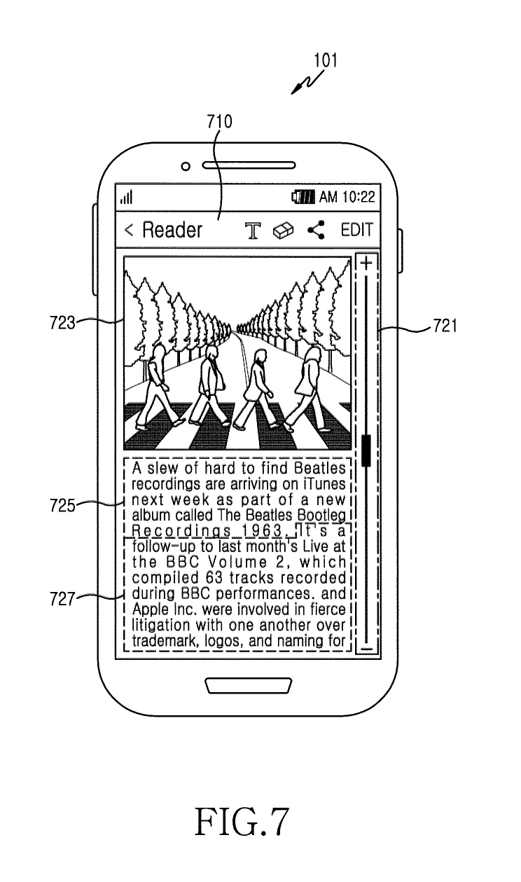

FIG. 7 is a diagram illustrating an example of providing summarized contents in an electronic device according to this disclosure. The electronic device 101 changes the substance of summarized contents provided in the electronic device 101 (such as displayed on the display 150), through a program (such as the contents processing program 135) of processing the summarized contents. The electronic device 101 receives contents summarized into two or more levels from the server 106. In receiving the summarized contents from the server 106, the electronic device 101 receives data of attribute information including information about the summarized contents together. The electronic device 101 adjusts a designated interface (such as the side bar 621 of FIG. 6) of a state of displaying a first level of contents summarized into three levels (such as the contents displayed on the display 150 in FIG. 6), to a second level (such as a side bar 721 of FIG. 7) in a display region 710. The electronic device 101 displays second-level contents among the summarized contents based on attribute information of the summarized contents. In displaying the second-level contents, the electronic device 101 displays the second-level contents in a manner of adding an addition portion 727 of the second-level contents to the existing displayed first-level contents 725 based on the attribute information of the summarized contents, or displays the second-level contents in a manner of changing the first-level contents (such as the contents 625 of FIG. 6) into the second-level contents (such as the contents 725 and the contents 727). In displaying the contents summarized into two or more levels, the electronic device 101 provides summarized contents of various types such as an image, a video, and an audio in accordance to divided levels, without being limited to the text as above.

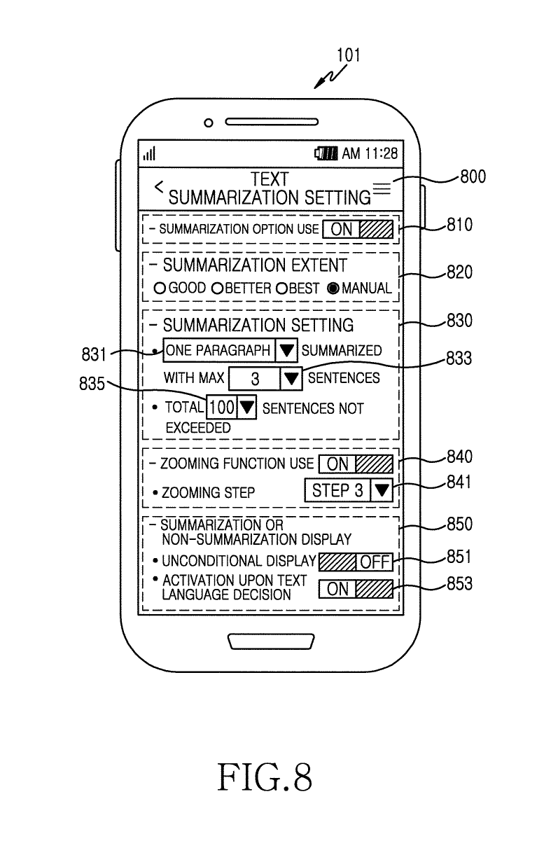

FIG. 8 is a diagram illustrating an example of setting a method of summarizing contents in an electronic device according to this disclosure. The electronic device 101 transmits contents of the electronic device 101 to the server 106 to summarize the contents of the electronic device 101 based on setting information (such as a request command) of the contents processing program 135. In an embodiment, the electronic device 101 inputs setting (such as contents summarization setting 800) a method of summarizing contents through the setting information of the contents processing program 135. The electronic device 101 provides an On/Off menu 810 of deciding whether to use a function of summarizing contents in the contents summarization setting 800. The electronic device 101 provides a menu 820 of setting the strength (or extent) of summarizing the original contents in the contents summarization setting 800. The electronic device 101 provides levels of a designated form such as ‘good’, ‘better’, ‘best’, or ‘manual’, in accordance to the extent of selecting, deleting, combining, and revising some of various objects included in the original contents. The electronic device 101 provides a detailed setting menu 830 capable of configuring setting when selecting ‘manual’ in the menu 820 of setting the strength of summarizing the original contents. The electronic device 101 provides to set summarization information that, in a case of summarizing a text included in the original contents, a designated range (such as one paragraph 831) of summarized contents includes how many sentences (such as three sentences 833), and the total number of sentences is how many sentences (such as one hundred sentences 835). The electronic device 101 provides to set a zooming function 840 of dividing the original contents into two or more summarized contents and displaying contents corresponding to at least one level in the contents summarization setting 800. The electronic device 101 provides a menu 841 of deciding the number of levels distinguishing the original contents through the zooming function. The electronic device 101 provides a menu 850 of deciding whether to set to display the summarization or non-summarization of contents that is being checked by a user in the electronic device 101 through the contents summarization setting 800. Without judging whether the electronic device 101 summarizes corresponding contents, the electronic device 101 provides a detailed menu of the menu 850, for example, provide a menu 851 of deciding to display (or activate) a contents summarization function. If turning off the menu 851, when satisfying at least one condition, the electronic device 101 provides a menu of deciding to display (or activate) the contents summarization function. According to one exemplary embodiment, the electronic device 101 provides a menu 853 of deciding to display (or activate) the contents summarization function when a language of a text included in contents is determined.

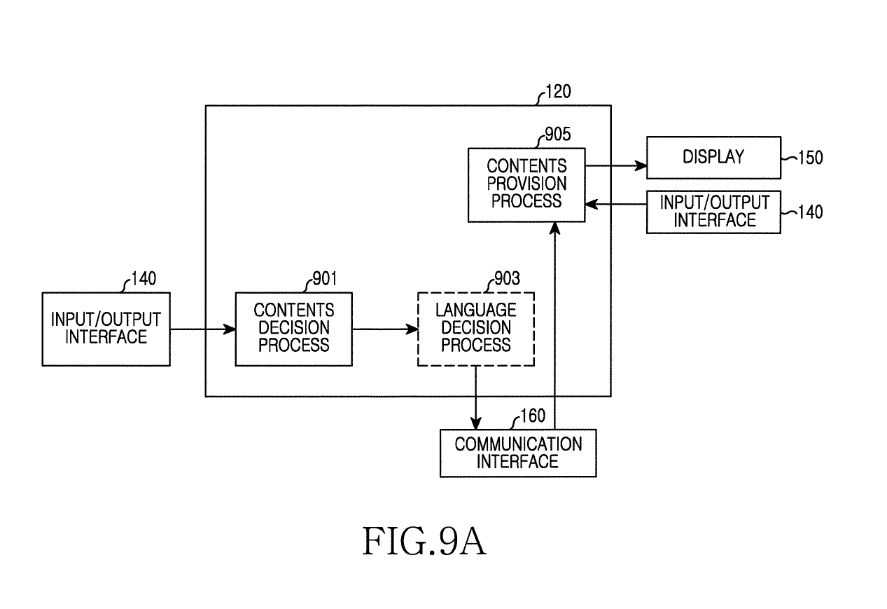

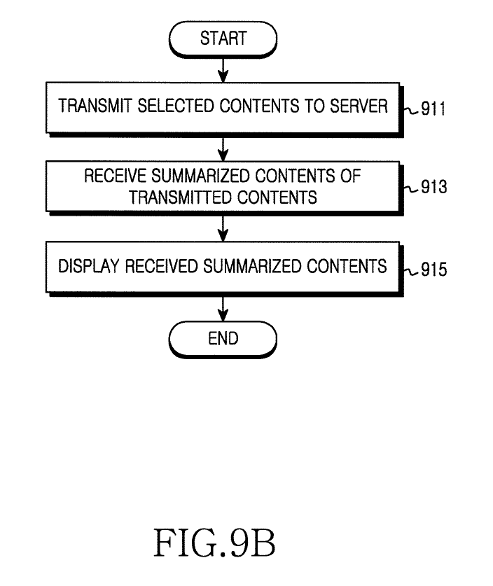

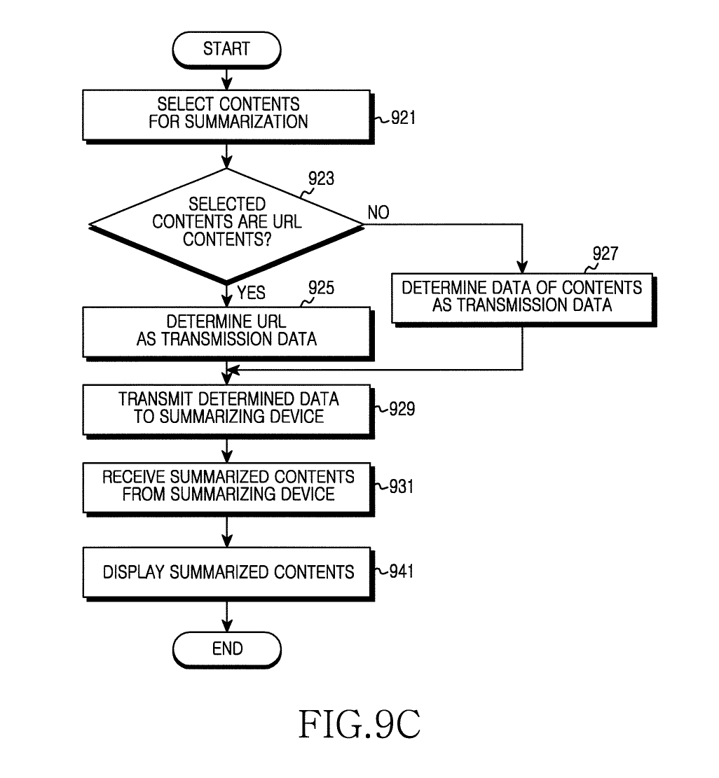

FIGS. 9A, 9B, and 9C illustrate an example of requesting and providing summarization of contents in an electronic device according to this disclosure. An operation according to various exemplary embodiments carried out in the electronic device 101 is an operation carried out by the processor 120 of the electronic device 101. The processor 120 controls at least one device included in the electronic device 101, thereby being able to perform various exemplary embodiments providing summarized contents.

Various exemplary embodiments of the present disclosure are described below with reference to FIG. 9A. In an embodiment, the processor 120 detects an input of requesting to summarize contents provided from an input/output interface 140 to the electronic device 101. If detecting information requesting summarization of the contents, the processor 120 performs a contents decision process 901. In the contents decision process 901, the processor 120 determines at least one to be transmitted to the server 106 among the original contents to be summarized, attribute information of the original contents, and a summarization command for a method of summarizing the original contents, based on setting information of the contents processing program 135. The processor 120 determines attribute information of contents to be summarized. Based on header information of contents, the processor 120 determines information such as a type of contents and a type of objects constructing the contents, as the attribute information of the contents. For example, if the contents to be summarized are an Internet page, the processor 120 determines an attribute of contents as the Internet page, and acquires an address of the Internet page. The processor 120 acquires data corresponding to at least one object among text or image and audio data included in the Internet page.

At a time point of deciding the original contents for summarizing, the processor 120 acquires a summarization command designated for a method of summarizing the original contents based on the setting information of the contents processing program 135. The processor 120 acquires information about a summarization method such as the total number of sentences of summarized contents determined in summarizing the original contents and the number of sentences included in one paragraph in the setting information of the contents processing program 135. In a language decision process 903, the processor 120 determines a language of a text included in contents to be summarized. According to one exemplary embodiment, the processor 120 determines a language included in an Internet page, and includes information about the determined language as a part of attribute information transmitted to the server 106. The processor 120 performs a process of deciding if contents are summarizable contents before the contents decision process 901, without being limited to performing the language decision process 903 after performing the contents decision process 901.

The processor 120 transmits at least one of the summarization command, the original contents, and the attribute information of the original contents which are determined based on the setting information of the contents processing program 135, to the server 106 through the communication interface 160. The processor 120 receives contents being summarized based on the original contents transmitted to the server 106, from the server 106 through the communication interface 160. In receiving the summarized contents, the processor 120 receives attribute information of the summarized contents including information such as an object included in the summarized contents and/or a method of constructing the summarized contents, together.

In a contents provision process 905, the processor 120 provides the received summarized contents to the electronic device 101. According to one exemplary embodiment, if receiving the attribute information of the summarized contents together with the summarized contents, the processor 120 checks if the summarized contents are distinguished into two or more levels based on the attribute information of the summarized contents, and determines a designated level of summarized contents to be firstly displayed based on the setting information of the contents processing program 135. Further, the processor 120 determines at least one program for providing the summarized contents based on a type of the summarized contents. According to one exemplary embodiment, the processor 120 checks a type of the received summarized contents through a header of the summarized contents or the attribute information of the summarized contents. The processor 120 determines at least one program based on the attribute information of the summarized contents, and provides the summarized contents through the determined program.

The processor 120 detects a control input inputted to the summarized contents provided through the display 150, through the input/output interface 140. According to one exemplary embodiment, the processor 120 detects an input of controlling to display contents of a second level in course of displaying on the display 150 contents of a first level among summarized contents distinguished into three levels. In response to the input, the processor 120 displays the contents of the second level among the summarized contents on the display 150.

As described above, various exemplary embodiments carried out by the electronic device 101 are carried out by the processor 120, and can be carried out by a module (such as a Micro Control Unit (MCU)) designated to perform the various exemplary embodiments. As discussed herein, various exemplary embodiments can be carried out by the processor 120 or the electronic device 101.

Various exemplary embodiments of the present disclosure are described below with reference to FIG. 9B. FIG. 9B is a flowchart illustrating an example of providing summarized contents in the electronic device 101 according to this disclosure. In operation 911, the electronic device 101 transmits selected contents to the server 106. The electronic device 101 determines the selected contents as the original contents, and transmits to the server 106 at least one of attribute information of the original contents and a summarization command designated for a method of summarizing the original contents based on setting information of the contents processing program 135.

In operation 913, the electronic device 101 receives contents summarized based on the transmitted original contents, from the server 106. The electronic device 101 receives the summarized contents from the server 106, and receives attribute information about the summarized contents. For example, the attribute information of the summarized contents received by the electronic device 101 from the server 106 includes information about a method of summarizing the original contents such as a case of distinguishing the summarized contents into two or more levels, or information about a type of the summarized contents. In receiving the attribute information of the summarized contents, the electronic device 101 receives the attribute information included in the summarized contents like a header of the summarized contents, and receives the attribute information as data separate from the summarized contents.

In operation 915, the electronic device 101 provides the received summarized contents. According to one exemplary embodiment, the electronic device 101 operates a program designated based on a type of the summarized contents and provide the summarized contents. For example, if the summarized contents are data created based on an image type, the electronic device 101 loads a program capable of processing an image and provide the summarized contents. If the summarized contents are distinguished into two or more levels, the electronic device 101 changes a level of the summarized contents provided in the electronic device 101 in accordance to an input detected through the input/output interface 140. If performing operation 915, the electronic device 101 ends the exemplary embodiment of FIG. 9B.

Various exemplary embodiments of the present disclosure are described below with reference to FIG. 9C. FIG. 9C is a flowchart illustrating an operation of providing summarized contents in the electronic device 101 according to this disclosure.

In operation 921, the electronic device 101 determines contents to be summarized. The electronic device 101 detects an input for summarizing the contents through the input/output interface 140. The electronic device 101 determines contents displayed on the display 150 as contents for summarizing, at a time point of detecting the input for summarizing. In operation 923, the electronic device 101 determines if the selected contents are contents of an Internet page including a URL address. When the selected contents are the contents of the Internet page including the URL address, the electronic device 101 performs operation 925 and, when not being the contents of the Internet page, the electronic device 101 performs operation 927.

In operation 925, the electronic device 101 determines an address of the Internet page, as data transmitted to the server 106 in order to summarize the contents. The electronic device 101 determines address data of the Internet page and attribute information representing that it is the address of the Internet page, as the original contents for transmitting to a summarizing device (such as the server 106). In operation 927, the electronic device 101 determines data corresponding to the selected contents, as data transmitted to the summarizing device (such as the server 106) in order to summarize the selected contents. If the selected contents are an electronic mail, the electronic device 101 downloads the corresponding electronic mail and determines created data as the transmission data. If the selected contents are document data including an image and/or text, the electronic device 101 determines the document data as the transmission data.

In operation 929, the electronic device 101 transmits at least one of data of the original contents determined to be transmitted, attribute information of the determined data, and a summarization command designated for a method of summarizing the original contents, to the summarizing device (such as the server 106). In operation 931, the electronic device 101 receives contents summarized based on the original contents, from the summarizing device (such as the server 106). In receiving the summarized contents, the electronic device 101 receives attribute information of the summarized contents designated for a method of summarizing the original contents into the summarized contents, together. The attribute information of the summarized contents received by the electronic device 101 is received as being included in a portion of the summarized contents, or is received as separate data.

In operation 941, the electronic device 101 provides the summarized contents. According to one exemplary embodiment, the electronic device 101 operates a program designated based on a type of the summarized contents and provide the summarized contents. If the summarized contents are distinguished into two or more levels, the electronic device 101 changes a level of the summarized contents provided in the electronic device 101, in accordance to an input detected through the input/output interface 140. If performing operation 941, the electronic device 101 ends the exemplary embodiment of FIG. 9B.

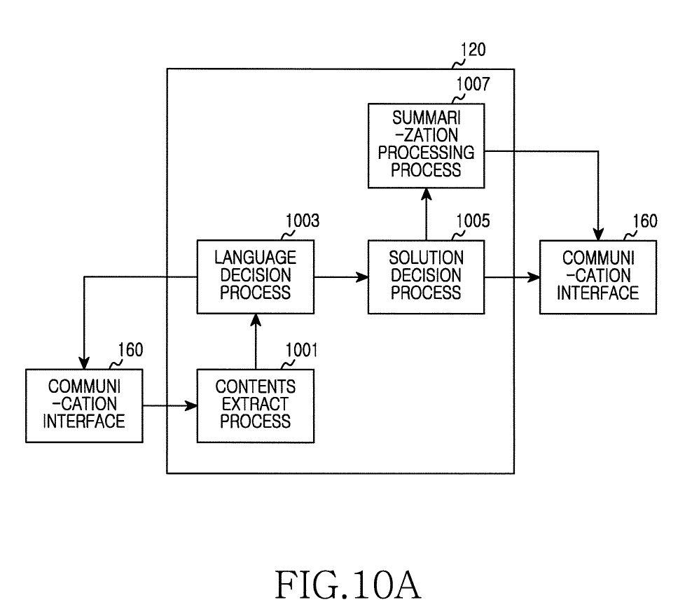

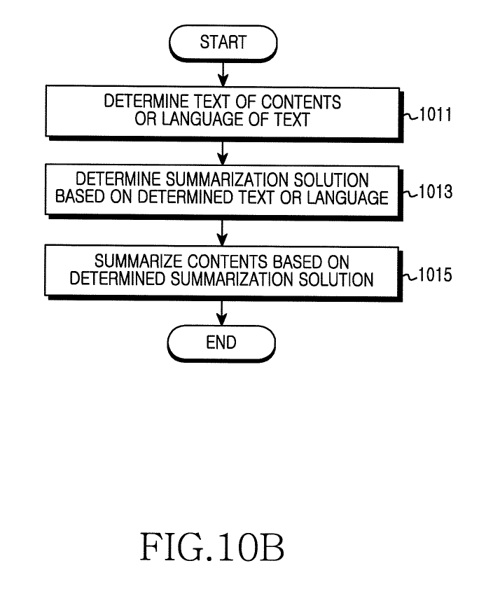

FIGS. 10A and 10B illustrate an example of summarizing received contents in an electronic device according to this disclosure. The electronic device 101 summarizes the original contents received from at least one other electronic device (such as the electronic device 102), and transmits the summarized contents to the specific electronic device (such as the electronic device 102) having transmitted the original contents. For example, the electronic device 101 performs a summarizing device (such as the server 106) requesting summarization of the original contents.

The processor 120 receives the original contents for summarizing from at least one other electronic device (such as the electronic device 102) through the communication interface 160. In receiving the original contents, the processor 120 receives attribute information of the original contents or a summarization command, together. If receiving the original contents, the processor 120 performs a contents extract process 1001. In the contents extract process 1001, the processor 120 extracts (or acquires) at least one content for summarizing, from the contents received from the other electronic device (such as the electronic device 102). The processor 120 acquires data such as at least one image, text or audio for summarizing from the original contents, based on the summarization command. The processor 120 determines and/or deletes at least one content determined irrelevant to the substance of the contents among the received original contents. If the original contents are an Internet page, the processor 120 selects and/or deletes contents of a designated attribute such as an advertisement image based on attribute information of contents included in the Interne page.

In a language decision process 1003, the processor 120 determines a language of a text acquired from the original contents. According to one exemplary embodiment, if the text acquired from the original contents is composed in two or more languages, the processor 120 determines at least one language among the languages of the text included in the original contents. Or, the processor 120 determines a text corresponding to a language designated to summarize based on a summarization command, in a text corresponding to at least one language acquired from the original text. To determine the language of the text included in the original contents, the processor 120 sends a request for deciding the language of the text to a device for deciding at least one language connected through the communication interface 140.

In a solution decision process 1005, the processor 120 determines a summarization solution corresponding to a characteristic of the original contents for summarizing based on a summarization command which is received from other electronic device (such as the electronic device 102) together with the original contents. The processor 120 determines a type of contents requested to summarize among the original contents based on the summarization command. The processor 120 determines summarization of the whole original contents based on the received summarization command, or determines to summarize at least one content among contents of various types such as an image, a text, an audio, and a video. Further, in a case of contents including a text or voice such as a video, an audio or an image, the processor 120 extracts the text or voice from the contents, and determines to summarize the extracted text or voice. The processor 120 determines a summarization solution of summarizing the contents in accordance to a type of the contents determined to be summarized. If the type of the contents determined to be summarized are a text, the processor 120 selects a summarization solution designated to summarize the contents in accordance to a language (such as English, Chinese, and Korean) of the text, the kind (such as news, a blog, and an e-mail) of data including the text, and the like.

The processor 120 transmits the original contents to a designated electronic device through the communication interface 160 such that the original contents are summarized by the summarization solution stored in the external of the electronic device 101. In a summarization processing process 1007, the processor 120 summarizes the original contents based on the selected summarization solution, and creates the summarized contents as data of a designated type. The processor 120 summarizes an image or text included in the original contents, and creates (or recreate data of other type) the summarized contents into an image, an audio, or a text based on setting information included in a received summarization command or information being set to the electronic device 101. The processor 120 transmits the summarized contents to the electronic device 102 through the communication interface 160. In transmitting the summarized contents to the electronic device 102, the processor 120 transmits attribute information such as a construction of the summarized contents or a type of the summarized contents, together.

Various exemplary embodiments of the present disclosure are described below with reference to FIG. 10B. FIG. 10B is a flowchart illustrating an example of summarizing contents in the electronic device 101 according to this disclosure. In operation 1011, the electronic device 101 determines a text included in the original contents or a language of the text. The electronic device 101 acquires the text included in the original contents received from at least one other electronic device (such as the electronic device 102), or determines a language of the text included in the original contents. In deciding the language of the text included in the original contents, the electronic device 101 transmits the original contents or the text included in the original contents to a specific electronic device connected by network communication such that the language is determined in the specific electronic device.

In operation 1013, the electronic device 101 determines a summarization solution for summarizing the original contents based on the acquired text or the determined language of the text. According to one exemplary embodiment, the electronic device 101 summarizes at least one image, audio, or text included in the original contents in accordance to a received summarization command. When summarizing the text, the electronic device 101 determines a summarization solution for summarizing a text included in the original contents and/or a text whose language is checked. If the text is included in the image, the electronic device 101 extracts the text included in the image, and determines a summarization solution for summarizing the text based on the extracted text. If a voice is included in the audio or video, the electronic device 101 extracts the voice included in the audio or video, and determines a summarization solution capable of summarizing the voice. Or, the electronic device 101 provides a summarization solution capable of converting the extracted voice into a text and summarizing the converted text. In deciding the summarization solution, the electronic device 101 also determines two or more summarization solutions based on attribute information of the original contents or a characteristic thereof.

In operation 1015, the electronic device 101 summarizes the original contents based on the determined summarization solution. In creating the summarized contents based on the original contents in accordance to the summarization command, the electronic device 101 creates as data of a type designated to the electronic device 101 or data of a type designated to the summarization command. According to one exemplary embodiment, the electronic device 101 creates the summarized contents as image data. For example, if the summarization contents include a text or image, the electronic device 101 arranges the image and/or text of the summarized contents based on a construction method of the original contents, and creates the image and/or text as image data. The electronic device 101 creates the summarized contents in a type of an audio or video. For example, if the summarized contents include text and/or image data, the electronic device 101 converts the text data into a designated voice and create audio data or video data.

Though not illustrated in FIG. 10B, the electronic device 101 transmits the summarized contents to the electronic device 102. When performing operation 1015 or transmitting the summarized contents to the electronic device 102, the electronic device 102 ends the exemplary embodiment of FIG. 10B.

Various exemplary embodiments carried out by the electronic device 101 includes an operation carried out by control of the processor 120. Further, the electronic device 101 includes a module constructed separately from the processor 120 and programmed to control the various exemplary embodiments of this disclosure. The separate module programmed to control the various exemplary embodiments of this disclosure is carried out by the control of the processor 120. The processor 120 transmits contents to be summarized, attribute information of the contents, and a summarization command to a server, and receive contents summarized in the server based on the attribute information of the contents and the summarization command.

Based on attribute information of contents received from the server 106, the processor 120 displays the received contents as any one or more of a text, a video, an audio, and an image. The processor 120 changes at least a portion of summarized contents displayed on the display 150 in accordance to a designated input detected in the electronic device 101. The processor 120 controls a method of displaying received contents based on attribute information of the received contents. The processor 120 displays contents corresponding to at least one level among two or more levels of a summarized text distinguished based on setting information of the received contents. The processor 120 determines attribute information of the received contents including information corresponding to at least one of a data type of the received contents, a program loaded corresponding to the data type, and a corresponding level when the received contents are distinguished into two or more levels in accordance to priority order. The processor 120 determines at least one of an Internet page, a document including at least one image or text, an image, an audio, and a video, as contents to be summarized. The processor 120 can select, omit, delete, revise, combine or rearrange at least a portion of the contents to be summarized based on the summarization command and create the summarized contents. The processor 120 determines priority order in at least a portion of the contents to be summarized. The processor 120 distinguishes the contents to be summarized, into two or more levels in accordance to the determined priority order based on the summarization command.

The electronic device provides an interface of summarizing and providing contents consumed by a user, thereby helping the user to consume information efficiently and quickly. The aforementioned constituent elements of the electronic device according to this disclosure can include one or more components, and the names of the corresponding constituent elements can be different in accordance to the kind of the electronic device. The electronic device according to this disclosure can include at least one of the aforementioned constituent elements, omit some constituent elements or further include additional other constituent elements. Also, some of the constituent elements of the electronic device according to this disclosure can be combined and constructed as one entity, thereby being able to identically perform functions of the corresponding constituent elements before combination.

An apparatus and method according to various exemplary embodiments stated in claims and/or specification of the present disclosure is implemented in a form (such as a module and a unit) including hardware, software, firmware, or a combination of two or more of the hardware, the software and the firmware. The module is also the minimum unit of an integrally constructed component or a part thereof. The module is also the minimum unit performing various exemplary embodiments of the present disclosure or a part thereof. The module is implemented mechanically or electronically. If being implemented by the software, a computer-readable storage medium storing one or more programs (such as programming modules and applications) is provided. For example, the software is implemented as an instruction stored in the computer-readable storage medium in a form of the programming module. The one or more programs include instructions for enabling the electronic device to execute the methods according to the exemplary embodiments stated in the claims and/or specification of the present disclosure. In a case where the instruction is executed by one or more processors (such as the processor 220), the one or more processors performs functions corresponding to the instructions. The computer-readable storage media is, for example, the memory 230. At least part of the programming module is, for example, implemented (such as executed) by the processor 220. At least part of the programming module includes, for example, a module, a program, a routine, a set of instructions, a process or the like for performing one or more functions.

The computer-readable recording media includes a magnetic media such as a hard disk, a floppy disk, and a magnetic tape, an optical media such as a Compact Disc-Read Only Memory (CD-ROM) and a Digital Versatile Disc (DVD), a Magneto-Optical Media such as a floptical disk, and a hardware device specially configured to store and perform a program instruction (such as the programming module) such as a Read Only Memory (ROM), a Random Access Memory (RAM), a flash memory and the like, an Electrically Erasable Programmable Read Only Memory (EEPROM), a magnetic disc storage device, or an optical storage device of other form, and a magnetic cassette. Or, the programs are stored in a memory constructed by a combination of some or all of them. Also, each constructed memory can be included in plurality.

Also, the programs are stored in an attachable storage device accessible through a communication network such as the Internet, an intranet, a Local Area Network (LAN), a Wireless LAN (WLAN) and a Storage Area Network (SAN), or a communication network constructed by a combination of them. This storage device accesses an electronic device through an external port. Also, a separate storage device on the communication network can access a portable electronic device. The aforementioned hardware device is configured to operate as one or more software modules in order to perform an operation of various exemplary embodiments of the present disclosure, and vice versa.

The module or programming module according to this disclosure includes at least one or more of the aforementioned constituent elements, or omit some of the aforementioned constituent elements, or include additional other constituent elements. Operations carried out by a module, the programming module or other constituent elements according to this disclosure can be executed in a sequential, parallel, repeated, or heuristic method. Also, some operations can be executed in different sequences, can be omitted, or other operations can be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method implemented using an electronic device, the method comprising:
transmitting contents to be summarized, attribute information of the contents, and a summarization command to a server, and
receiving contents from the server that are summarized based on the attribute information of the contents and the summarization command.

2. The method of claim 1, further comprising displaying the received contents as any one or more of a text, a video, an audio, and an image, wherein the received contents are displayed based on attribute information of the contents received from the server.

3. The method of claim 2, further comprising changing at least a portion of the summarized contents displayed on a display in accordance with a designated input detected by the electronic device.

4. The method of claim 2, further comprising controlling a displaying method of the received contents based on the attribute information of the received contents.

5. The method of claim 2, wherein displaying the received contents comprises displaying contents corresponding to at least one level among two or more levels of a summarized text distinguished based on setting information of the received contents.

6. The method of claim 2, wherein the attribute information of the received contents comprises information corresponding to at least one of a data type of the received contents, a program loaded corresponding to the data type, and a corresponding level when the received contents are distinguished into two or more levels in accordance to a priority order.

7. The method of claim 1, wherein the contents to be summarized are at least one of an Internet page, a document comprising at least one image or text, an image, an audio, and a video.

8. The method of claim 1, further comprising creating, by the server, the summarized contents by selecting, omitting, deleting, revising, combining or rearranging at least a portion of the contents to be summarized based on the summarization command.

9. The method of claim 1, further comprising deciding, by the server, a priority order for at least a portion of the contents to be summarized.

10. The method of claim 9, further comprising distinguishing, by the server, the contents to be summarized into two or more levels in accordance with the determined priority order based on the summarization command.

11. An electronic device comprising:
a communication interface configured to transmit and receive contents; and
at least one processor configured to control the transmission of contents to be summarized, attribute information of the contents, and a summarization command to a server, and receive contents from the server that are summarized in the server based on the attribute information of the contents and the summarization command.

12. The device of claim 11, wherein the processor is configured to control a display of the received contents from the server as any one or more of a text, a video, an audio, and an image based on attribute information of the received contents.

13. The device of claim 12, wherein the processor is configured to change at least a portion of the summarized contents displayed on a display in accordance with a designated input detected in the electronic device.

14. The device of claim 12, wherein the processor is configured to control a displaying method of the received contents based on the attribute information of the received contents.

15. The device of claim 12, wherein the processor is configured to control a display of contents corresponding to at least one level among two or more levels of a summarized text distinguished based on setting information of the received contents.

16. The device of claim 12, wherein the processor is configured to determine the attribute information of the received contents comprising information corresponding to at least one of a data type of the received contents, a program loaded corresponding to the data type, and a corresponding level when the received contents are distinguished into two or more levels in accordance with a priority order.

17. The device of claim 11, wherein the processor is configured to determine the contents to be summarized as at least one of an Internet page, a document comprising at least one image or text, an image, an audio, and a video.

18. The device of claim 11, wherein the server is configured to create the summarized contents by selecting, omitting, deleting, revising, combining or rearranging at least a portion of the contents to be summarized based on the summarization command.

19. The device of claim 11, wherein the server is configured to determine a priority order for at least a portion of the contents to be summarized.

20. The device of claim 19, wherein the server is configured to distinguish the contents to be summarized into two or more levels in accordance with the determined priority order based on the summarization command.
